(19) United States
(12) Patent Application Publication
(10) Pub. No.: US 2008/0258986 A1
(43) Pub. Date: Oct. 23, 2008

(54) ANTENNA ARRAY FOR A HI/LO ANTENNA BEAM PATTERN AND METHOD OF UTILIZATION

(76) Inventors: Celite Milbrandt, Austin, TX (US); Guiping Zheng, Austin, TX (US); Michael B. Kindig, Austin, TX (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/039,692

(22) Filed: Feb. 28, 2008

Related U.S. Application Data
(60) Provisional application No. 60/892,083, filed on Feb. 28, 2007.

(51) Int. Cl. H01Q 3/02

(52) U.S. Cl. 343/757

(57) ABSTRACT

Antenna arrays configured to produce directional antenna beam patterns are described. An antenna array produces a Hi antenna beam pattern and a Lo antenna beam pattern. Based on received satellite information, a mechanically scanning directional antenna system operates to adjust the azimuth direction of the antenna between the two beam patterns to maintain optimum satellite signal reception at different geographical locations and different elevation angles. In one embodiment an antenna mechanically adjusts direction based on geographical location information such as latitude and longitude received by a Global Positioning System (GPS) receiver. In another embodiment, an antenna mechanically adjusts its direction based on received satellite quality metrics such as signal to noise ratio, bit error rate, and/or received power, and uses these signal quality metrics to track the satellite.

### RELATED APPLICATIONS

This application claims priority under 35 U.S.C. § 119(e) to U.S. Provisional Patent Application Ser. No. 60/892,083, entitled ANTENNA ARRAY FOR A HI/LO ANTENNA BEAM PATTERN AND METHOD OF UTILIZATION, filed Feb. 28, 2007. This application is related to U.S. Utility patent application Ser. No. 11/923,554, entitled SYSTEMS AND DEVICES FOR PERSONALIZED RENDERING OF DIGITAL MEDIA CONTENT and to U.S. Utility patent application Ser. No. 12/011,193, entitled DEVICES AND METHODS FOR DISTRIBUTING DIGITAL CONTENT. The contents of each of these applications is hereby incorporated by reference herein in its entirety for all purposes.

### FIELD OF THE INVENTION

The present invention relates generally to antenna arrays for directional antennas. More particularly but not exclusively, the invention relates to antenna arrays for directional antennas that produce distinct beam patterns, preferably High (Hi) and Low (Lo) angle beam patterns, as well as methods of operation of antenna arrays with mechanical controls to utilize the advantages of Hi/Lo antenna beam patterns, including in conjunction with.

### BACKGROUND

Antennas in the telecommunications industry have greatly evolved over time. Traditional directional antennas radiate energy in one direction in reference to a specific three dimensional plane. This significantly limits their reception range to a very small coverage area. Traditional satellite-mobile antenna receiver units utilize basic omni-directional design, with reference to a specific three dimensional plane, wherein the antenna radiates energy in all directions. This approach requires a strong signal to overcome the low gain and short range of these antennas.

As an alternative to traditional satellite-mobile antenna receiver units, telecommunications technology has evolved towards using smart antenna technology that combines antenna elements with complex digital signal processing capabilities. These antennas optimize signal reception by automatically changing the direction of their radiation pattern based on the signal environment. Smart antennas provide a number of advantages over traditional antennas such as improved coverage area, decreased interference and increased capacity.

One example of a smart antenna is the switched beam antenna, which produces a number of predefined fixed beam patterns. Based on signal strength, this antenna uses algorithms to determine which beam is best aligned in the direction of the signal of interest, and then uses phase shifters to switch to that beam pattern. Another type of smart antenna is the adaptive array antenna. The adaptive array antenna may employ a large number of radiation patterns using complex digital processing algorithms to steer its radiation beam toward a user.

The complex electronics and algorithms required for smart antennas cause them to be extremely expensive to produce. As a result of this complexity and cost, the many performance improvements possible with smart antennas have yet to be realized, even though there is a great need and commercial interest in the technology.

Consequently, new approaches are needed that provide higher antenna performance at reduced cost.

### SUMMARY

The present invention relates generally to directional antenna arrays and associated apparatus that advantageously permit benefits of a smart antenna at a lower cost. Typical embodiments include a directional antenna arrangement producing two beam patterns, preferably a Hi beam pattern and a Lo beam pattern, along with an associated receiver unit. The antenna array is configured to allow adjustment of the azimuth direction between the two beam patterns to maintain optimum satellite signal reception at different geographical locations and elevation angles.

In accordance with one embodiment, antenna direction is mechanically adjusted based on geographic location information, such as latitude and longitude, provided by a satellite positioning system such as a Global Positioning System (GPS) receiver.

In accordance with another embodiment, an antenna is mechanically adjusted to a specific antenna beam pattern based on received satellite signal information such as signal to noise ratio, bit error rate, received power, and/or other signal quality metrics. The antenna unit may then track the satellite using these signal quality metrics.

In accordance with another embodiment, a mechanically scanning directional antenna with a Hi/Lo radiation pattern switches beam patterns using simple electromechanical technology. The antenna array steers itself towards the received signal without using complex and expensive digital processing algorithms.

In accordance with another embodiment, in a system with a Hi/Lo antenna radiation pattern, a mechanically scanning directional antenna provides improvement in range and coverage by maximizing the gain of the received satellite signal.

Additional aspects of the present invention are described herein.

### BRIEF DESCRIPTION OF THE DRAWINGS

The invention is more fully appreciated in connection with the following detailed description taken in conjunction with the accompanying drawings, wherein:

FIG. 1A illustrates an antenna array configured to produce two antenna beam patterns.

FIG. 1B is a block diagram of an antenna receiver unit in accordance with an embodiment of the present invention.

FIG. 2 illustrates a satellite-mobile unit receiver in accordance with an embodiment of the present invention.

FIG. 3A shows a traditional radiation pattern of a directional antenna.

FIG. 3B shows a Hi/Lo radiation pattern in accordance with an embodiment of the present invention.

FIG. 3C shows a three dimensional view of a Hi/Lo radiation pattern in accordance with an embodiment of the present invention.

FIG. 4 is a simplified flow chart of a method in accordance with an embodiment of the present invention.

FIG. 5 is a simplified flow chart of a method in accordance with an embodiment of the present invention.

### DETAILED DESCRIPTION

The present invention relates generally to directional antenna arrays and associated apparatus that advantageously permit benefits of a smart antenna at a lower cost. Typical embodiments include a directional antenna arrangement producing two beam patterns, preferably a Hi beam pattern and a Lo beam pattern, along with an associated receiver unit. The antenna array is configured to allow adjustment of the azimuth direction between the two beam patterns to maintain optimum satellite signal reception at different geographical locations and elevation angles.

In accordance with one embodiment, antenna direction is mechanically adjusted based on geographic location information, such as latitude and longitude, provided by a satellite positioning system such as a Global Positioning System (GPS) receiver.

In accordance with another embodiment, an antenna is mechanically adjusted to a specific antenna beam pattern based on received satellite signal information such as signal to noise ratio, bit error rate, received power, and/or other signal quality metrics. The antenna unit may then track the satellite using these signal quality metrics.

In accordance with another embodiment, a mechanically scanning directional antenna with a Hi/Lo radiation pattern switches beam patterns using simple electromechanical technology. The antenna array steers itself towards the received signal without using complex and expensive digital processing algorithms.

In accordance with another embodiment, in a system with a Hi/Lo antenna radiation pattern, a mechanically scanning directional antenna provides improvement in range and coverage by maximizing the gain of the received satellite signal.

Additional aspects of the present invention are further described below and illustrated in the figures.

In the following description reference is made to the accompanying drawings wherein are shown, by way of illustration, several embodiments of the present invention. It is understood by those of ordinary skill in the art that other embodiments may be utilized and structural changes made without departing from the spirit and scope of the present invention.

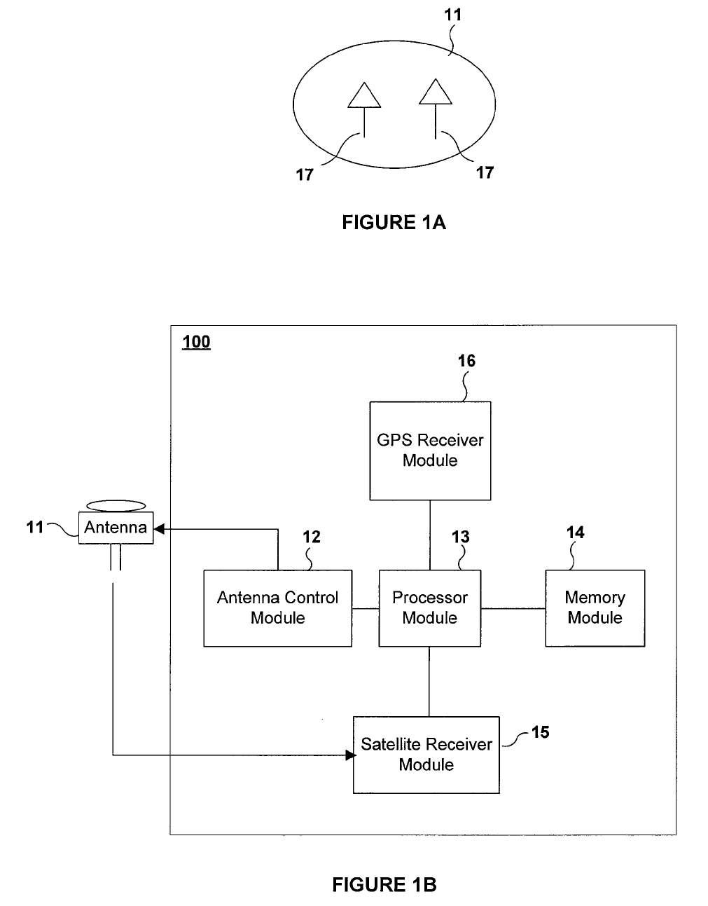

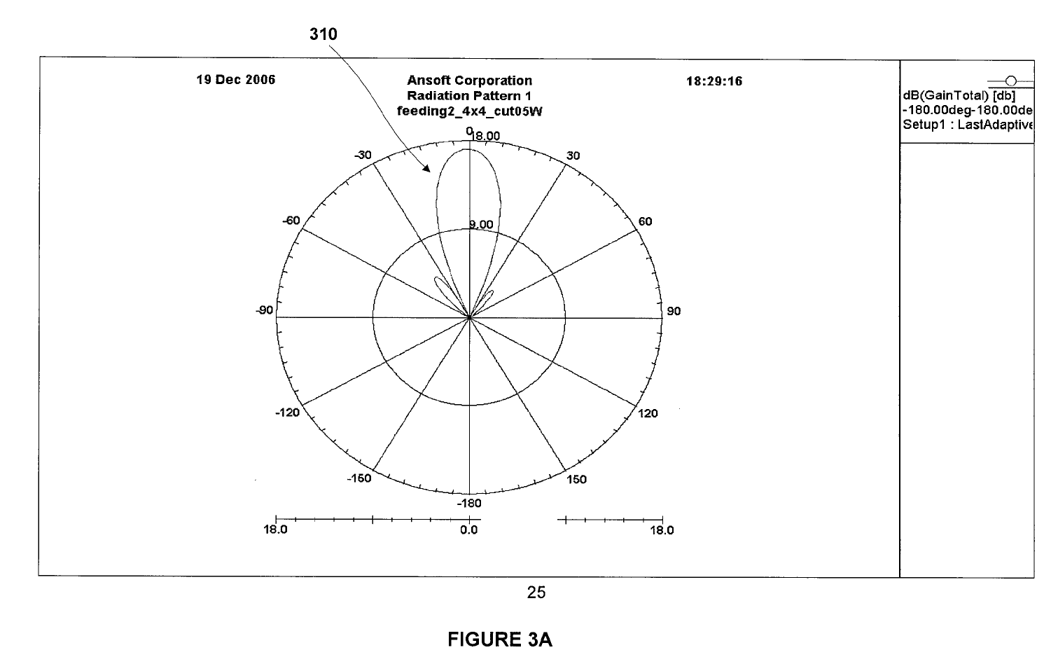

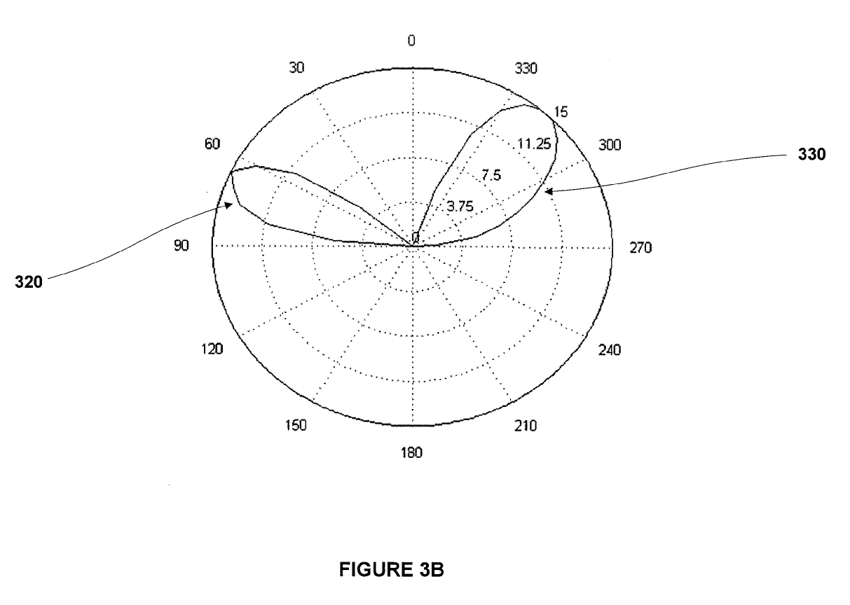

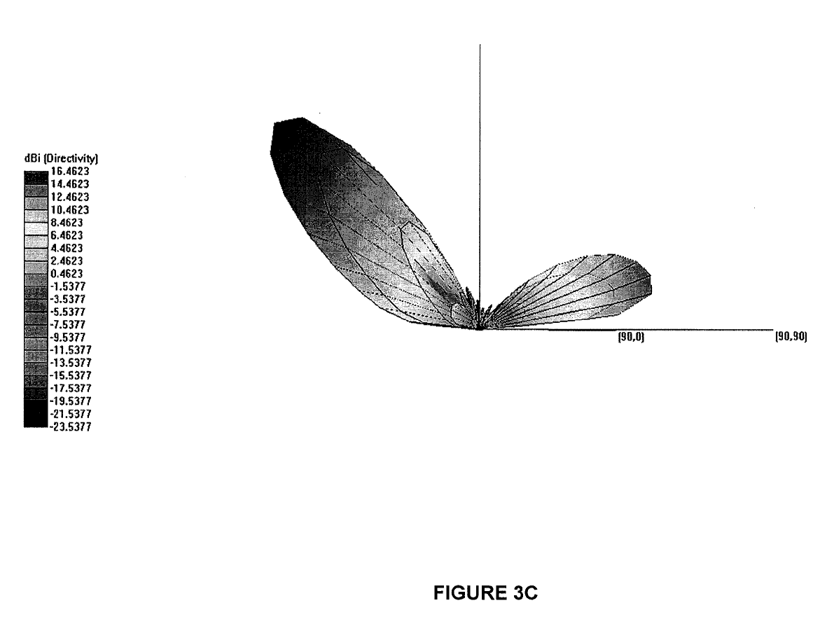

Attention is now directed to FIG. 1A, which is a simplified illustration of an antenna arrangement 11 (also denoted for brevity herein as antenna 11) in accordance with an embodiment of the present invention. The antenna arrangement 11 preferably comprises an antenna array of two or more antenna elements 17 spatially arranged and interconnected (not shown) to produce two or more directional antenna beam patterns such as are shown in FIGS. 3B and 3C. The beam patterns preferably include a Hi beam pattern and a Lo beam pattern, where the term Hi denotes a beam pattern at a high elevation angle and Lo denotes a beam pattern at a low elevation angle. Antenna arrangement 11 used for various embodiments may be a microstrip patch antenna, or any other directional antenna suitable for satellite signal reception. The antenna arrangement 11 may be configured for operation in satellite bands such as the Ku-band, X-band, or S-band, as well as other bands.

FIG. 1B is a simplified block diagram of a receiver unit 100 for use with the antenna arrangement 11 in a satellite-to-mobile communications system, in accordance with aspects of the present invention. The antenna receiver unit 100 may be incorporated in or connected to a mobile unit (not shown) used to receive, store, play or otherwise use data or content provided to a user. For example, the mobile unit may comprise a portable device for digital content rendering as is described in U.S. patent application Ser. Nos. 11/923,554 and 12/011,193, incorporated by reference herein.

The receiver unit 100 is illustrated in simplified form in FIG. 1B including basic elements described further below with respect to their functionality. However, it is noted that other elements may also be included in addition to, or in place of, those shown. In addition, the respective elements may contain additional components including hardware and/or software which are not specifically shown in the figures for purposes of clarity.

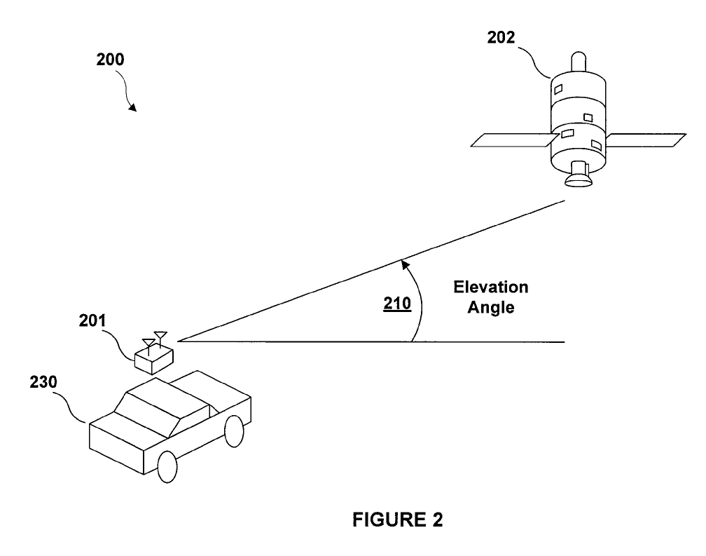

Receiver unit 100 may include an optional location receiver module, such as the GPS receiver module 16 shown in FIG. 1B, including a GPS antenna (not shown), for providing data related to position and/or heading associated with the location of receiver unit 100. Receiver unit 100 may also include: an antenna control module 12 to facilitate mechanical positioning of antenna 11; a satellite receiver module 15 for receiving digital content from a satellite or satellites; a processor module 13 for processing data received from the satellite receiver module 15 and/or GPS receiver module 16 and providing output data and/or control information; and a memory module 14 to store programs to be executed in processor module 13, as well as data received, used or provided by processor module 13. While antenna 11 is illustrated separately from receiver unit 100 in FIG. 1B, in some embodiments antenna 11 may be part of or integrated in receiver unit 100, and antenna 11 and receiver unit 100 may be part of or integrated in a mobile device such as mobile unit 201 shown in FIG. 2.

Antenna control module 12 may include electrical, electronic, mechanical and/or electromagnetic elements configured to receive control data or signals from processor module 13 and facilitate movement of antenna 11 to position the Hi/Lo beam patterns of antenna 11 to a desired position. For example, antenna control module 12 may comprise electronics and an electrical motor, such as a DC motor, stepper motor, or other type of electromagnetic motion producing device, configured to rotate or translate antenna 11 to adjust the position of the Hi/Lo beam patterns. Adjusting the position may comprise rotating the antenna 11 with respect to a connected housing or mounting base. In some embodiments antenna control module 12 may be separated in part from antenna 11 as shown in FIG. 1B, however, in other embodiments antenna control module 12 may be incorporated in or integrated with antenna 11. In addition, receiver unit 100 and/or antenna 11 may be mounted in a common case or housing, that may comprise a mobile unit 201 as illustrated in FIG. 2.

Processor module 13 may include a microcontroller, microprocessor, digital signal processor and/or other type of digital processor configured to execute instructions contained in one or more software modules (not shown), as well as other elements such as input/output (I/O) interfaces, memory, control components and/or other peripheral components. Data and/or software may be stored in memory module 14 coupled to the processor module 13.

In one embodiment, GPS receiver module 16 receives signals from a GPS satellite positioning system (not shown) and generates geographical position data for the receiver unit 100, such as location data. This information may be stored in memory module 14. The processor module 13 then receives this geographical position data and, based at least in part on the data, selects between the Hi and Lo antenna beam patterns of antenna 11. The beam pattern may be selected to produce the maximum amount of gain, and therefore the optimal signal reception, based on receiver unit 100's location. For example, processor module 13 may receive location data from GPS receiver module 16 and then select one of the Hi or Lo antenna beam patterns based on receiver unit 100's current location, the location of a targeted geostationary satellite, such as satellite 202 illustrated in FIG. 2, and the relative elevation angle 210 of satellite 202 with respect to the receiver unit 100.

Processor module 13 may then generate antenna element control data to facilitate positioning of the antenna 11, in conjunction with antenna control module 12, to the selected beam pattern. The antenna element control data may be stored in memory module 14. In addition, data received at satellite receiver module 15 and/or provided to processor module 13, such as digital content as described in U.S. patent application Ser. Nos. 11/923,554 and 12/011,193 may also be stored in memory module 14.

In some embodiments, data related to determining appropriate beam patterns based on received signal information may be programmed in the processor module 13 and/or the associated memory module 14 in a memory structure. For example, receiver unit 100 may store, in processor module 13 or in memory module 14, a lookup table or other data structure that includes location information for one or more satellites to be targeted for reception, and then processor module 13 may use this information to select the appropriate Hi or Lo beam pattern based on the current location of the receiver unit 100, provided by the GPS module 16, relative the desired satellite to be tracked.

For example, a receiver unit 100 operating at a certain latitude and longitude, such as in Texas, may select one beam pattern, such as the Hi beam pattern, based on a relatively high elevation angle between the receiver unit 100 and the targeted geostationary satellite; whereas a unit operating at a different latitude and longitude, for example in Maine, may select another beam pattern, such as the Lo beam pattern, based on a relatively low elevation angle between the receiver unit 100 and the same targeted geostationary satellite. Typically the choice will be between one of two beam patterns; however, in some embodiments more than two beam patterns may be provided by antenna 11, with corresponding selection based on the optimal beam pattern with respect to receiver unit 100's current position with respect to the geostationary satellite, such as satellite 202.

In another embodiment of receiver unit 100, a satellite receiver module 15 receives a signal from a satellite, such as geostationary satellite 202, and provides information related to the satellite signal that may include, but is not limited to, signal to noise ratio, bit error rate, received power and/or other performance parameters to processor module 13. Alternately, in some embodiments, satellite receiver module 15 may merely provide a received signal output to processor module 13, with processor module 13 generating the performance parameters. In either case, processor module 13 may then process the received information to determine which of the Hi or Lo beam pattern will optimize reception of the received satellite signal. Processor module 13 may then generate antenna element control data to facilitate positioning of antenna 11 in conjunction with antenna control module 12 to the selected beam pattern to maximize gain. Processor module 13 may also be used to further track the satellite signal in conjunction with receiver module 15 and antenna control module 12.

The antenna element control data may be stored in memory module 14. In addition, data received at satellite receiver module 15 and/or provided to processor module 13, such as digital content as described in U.S. patent application Ser. Nos. 11/923,554 and 12/011,193, may also be stored in memory module 14.

In accordance with the above embodiment, a GPS receiver module 16 is typically not used in receiver unit 100, and the Hi/Lo beam selection and/or satellite tracking is based on performance parameters of the satellite provided by the satellite receiver module 15 alone. However, it is noted that in some embodiments receiver unit 100 may include both a GPS receiver module 16 and satellite receiver module 15, with Hi/Lo beam selection and/or satellite tracking based on information or signals provided by GPS receiver module 16, satellite receiver module 15, or both GPS receiver module 16 and satellite receiver module 15.

As noted previously, one of the Hi/Lo beam patterns may be selected to maximize gain of an antenna such as antenna 11. In some embodiments, maximization of antenna gain may be determined as follows. The gain of an antenna is maximum in the direction of the maximum radiation, and the maximum radiation is at the electromagnetic axis of the antenna, also known as the boresight. A typical single beam antenna only has one boresight, so as the boresight moves away from the received signal, such as a signal provided by satellite 202, the received power will be less and therefore the gain will be less. A Hi/Lo antenna such as antenna 11, however, will have two (or more) radiation patterns (boresights). As the received signal moves away from one boresight and the received power decreases, the antenna 11 can be adjusted in conjunction with processor module 13 and antenna control module 12 to the other boresight and the received power may then increase. By selecting the antenna pattern with the greater received signal, the antenna 11 can oriented to maximize received power, thus maximizing gain.

In addition to maximizing gain, a variety of other signal metrics may be used either alone or in combination to select the optimal beam pattern. In one embodiment, processor module 13 may determine a signal quality metric for the currently received signal and compare it to a signal quality metric of previously received signals, to test whether the current signal metric is better than a previous one or vice versa. Processor module 13 may then determine which beam pattern currently has the signal corresponding to the highest signal quality metric. For example, signal to noise ratio (SNR) may be used as one signal quality metric. If the SNR of a first received signal corresponding to the Hi beam pattern is better than the SNR of a second received signal corresponding to the Lo beam pattern, then the processor module 13 will choose the antenna 11 beam pattern corresponding to the first received signal (i.e. the Hi beam pattern).

In addition to using a single signal quality metric, several signal quality metrics may be used in combination. For example, SNR and bit error rate (BER) may be used together. In one embodiment, if SNR and BER combined are better for the first signal than for the second signal (as described above), then the processor module 13 will choose an antenna beam pattern corresponding to the first signal. It will be noted that other performance metrics alone or in combination may also be used.

Satellite tracking, as described previously, may be done with a variety of satellite tracking methods as are known in the art, including programmed tracking, computed tracking or closed-loop automatic tracking. In one exemplary embodiment, programmed tracking may be used, with a preprogrammed GPS heading which correlates to the position of the satellite and adjusts the antenna 11 dependent on the signal to noise ratio.

In the embodiments as described previously, as well as in others, antenna control module 12 may be used in conjunction with processor module 13 to facilitate adjustment of the azimuth direction of antenna 11 to an appropriate beam pattern to maintain optimum satellite signal reception. Also, based on the antenna element control data, antenna control module 12 may further operate to adjust the position of the antenna 11 in order to track the received satellite signal. Data such as the element control data in either embodiment may be stored in memory module 14. A receiver unit 100 according aspects of the present invention may provide significant performance improvements over traditional satellite to mobile receivers that do not mechanically adjust the antenna 11 between two distinct beam patterns.

FIG. 2 illustrates a satellite to mobile system 200 including a satellite 202 and a mobile unit 201 in accordance with embodiments of aspects of the present invention. Mobile unit 201 may include a receiver unit 100 and an antenna 11 such as is illustrated in FIG. 1B, and may also comprise a portable device with content rendering functionality and components such as are described in U.S. patent application Ser. Nos. 11/923,554 and 12/011,193, incorporated by reference herein. Mobile unit 201 may be configured to operate in an automobile or other vehicle 230 as shown in FIG. 2 to receive a signal from satellite 202, at an elevation angle 210, and process the received information into antenna control element data used to position an antenna element of mobile unit 201, such as antenna 11, as was described previously. In addition, as described previously, mobile unit 201 may also be configured to receive signals from a position location system, such as a GPS system (not shown), to generate position information related to the position of the mobile unit 201 relative to the satellite 202, and use this position information to generate control element data to be used in addition to, or in place of, the control element data associated with satellite 202.

Based on the control element data, mobile unit 201 determines which beam pattern of an associated antenna, such as antenna 11, is optimal, typically either a Hi or Lo beam pattern of antenna 11. Antenna 11 may then be positioned to the appropriate beam pattern to optimize the gain of the signal received at different elevation angles. As noted previously, a satellite-mobile receiver unit operating in Texas will likely utilize a different beam pattern than the same receiver unit operating in Maine due to the differences in location and elevation.

In typical embodiments, only the azimuth angle of the antenna 11 will be adjusted to maximize reception of content. However, in some embodiments the elevation antenna of the antenna 11 may also be adjusted, either alone or in combination with the azimuth angle.

Also, as noted previously, in some embodiments a hybrid process may be used to track the satellite signal, with the initial positioning of antenna 11 of mobile unit 201 being determined as described previously using a GPS signal provided by GPS receiver module 16, and with the azimuth angle then further adjusted based on the signal quality metric of the satellite signal provided by satellite 202, rather than the GPS position information.

FIG. 3A illustrates a traditional directional antenna radiation pattern, which consists of one main lobe 310 along with additional minor lobes. In contrast to this traditional pattern, FIG. 3B shows a Hi/Lo antenna radiation pattern in accordance with aspects of the present invention. The Hi/Lo antenna radiation pattern preferably comprises two distinct main lobes along with minor lobes (which are not depicted). As shown in FIG. 3B, as one example, a high beam pattern 320 has theta ranging from 40 degrees to 55 degrees, in which phi is equal to 90 degrees, and a low beam pattern 330 has theta ranging from 55 degrees to 70 degrees, in which phi is equal to 270 degrees. Depending on the received satellite information and/or GPS location information, antenna 11 may be rotated mechanically to either the Hi beam pattern or the Lo beam pattern to achieve maximum signal reception. To further illustrate a Hi/Lo antenna radiation pattern, FIG. 3C shows a three dimensional version of the radiation pattern of an antenna, such as antenna 11, in accordance with one embodiment of the present invention.

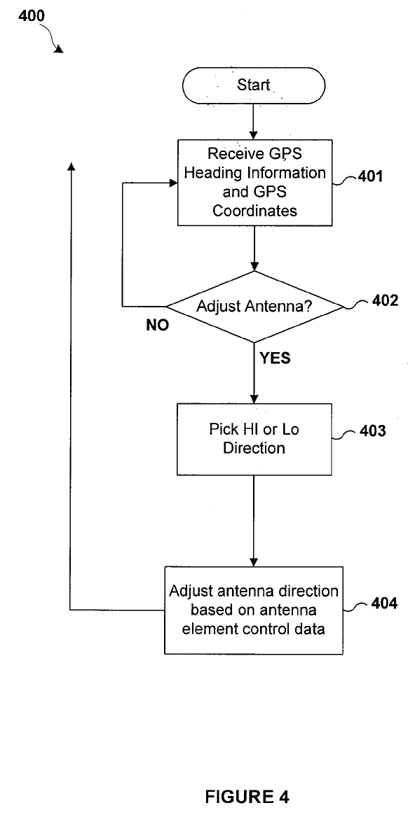

A method for Hi/Lo antenna adjustment in accordance with one embodiment of the present invention is shown in FIG. 4, wherein an antenna, such as antenna 11, is mechanically adjusted based on geographical location and elevation angle information to optimize reception from a satellite such as satellite 202. An antenna receiver unit, such as unit 100 as shown in FIG. 1, receives GPS heading information and GPS coordinates at stage 401 via a GPS receiver module 16 from a GPS satellite. At stage 402, based on the GPS data received, the processor module 13 of the unit 100 determines if the direction of the antenna should be adjusted. If so, at stage 403 the processor module 13 determines which beam pattern (typically of the Hi or Lo beam patterns) will produce the best signal reception. At stage 404, the antenna 11 is aligned in the appropriate azimuth direction, based on either the Hi or Lo antenna beam, in the direction of the received satellite signal. Depending on the quality of the received signal and/or other criteria, the antenna 11 may be adjusted again by repeating the process starting at stage 401.

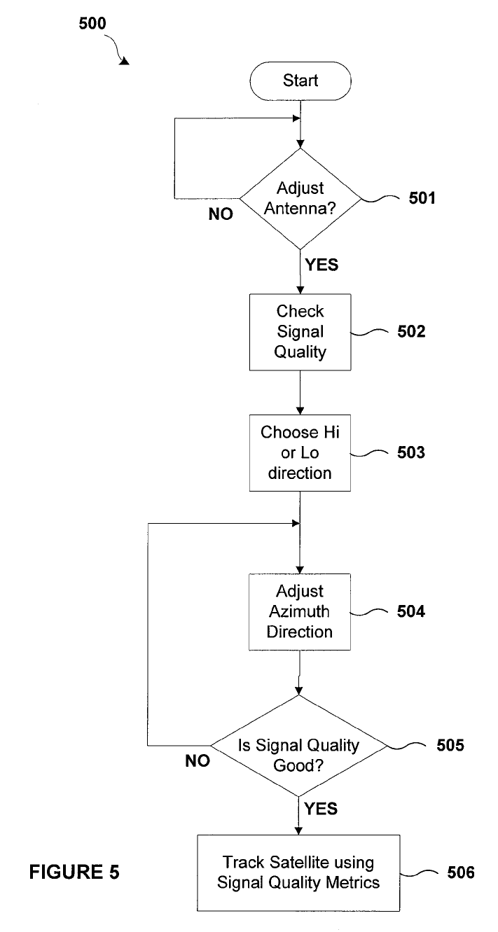

A method for Hi/Lo antenna adjustment in accordance with another embodiment of the present invention is shown in FIG. 5, wherein an antenna, such as antenna 11, is mechanically adjusted based on satellite signal information, such as from satellite 202 as shown in FIG. 2. At stage 501 an initial adjustment of antenna 11 may be made to optimize signal reception from satellite 202. Processor module 13 checks the quality of the signal being received at stage 502, using such parameters as signal-to-noise ratio, adjacent channel interference and/or other parameters indicative of signal quality. Based on the signal quality information, processor module 13 may then select a beam pattern (typically either the Hi or Lo antenna beam pattern) at stage 503 and then the position of antenna 11 is adjusted in the azimuth direction at stage 504 to correspond with the antenna pattern chosen. At decision stage 505 the quality of the signal is checked again. If the signal quality is good, at stage 506 the antenna receiver then tracks the satellite from which the signal is received using, for example, the signal quality metrics. If the signal quality is not good at stage 505, then process execution may be returned to stage 504 and the azimuth direction adjusted again.

Some embodiments of the present invention may include computer software and/or computer hardware/software combinations configured to implement one or more processes or functions associated with the present invention, such as those described above. These embodiments may be in the form of modules implementing functionality in software and/or hardware software combinations. Embodiments may also take the form of a computer storage product with a computer-readable medium having computer code thereon for performing various computer-implemented operations, such as operations related to functionality as describe herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in hardwired circuitry in place of, or in combination with, machine-executable software instructions.

The foregoing description, for purposes of explanation, used specific nomenclature to provide a thorough understanding of the invention. However, it will be apparent to one of ordinary skill in the art that specific details are not required in order to practice the invention. Thus, the foregoing descriptions of specific embodiments of the invention are presented for purposes of illustration and description, not limitation. They are not intended to be exhaustive or to limit the invention to the precise forms disclosed; obviously, many modifications and variations are possible in view of the above teachings without departing from the spirit and scope of the invention as set forth in the claims.

The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

I claim:

1. A Hi/Lo antenna system, comprising:
an antenna array including a plurality of antenna elements configured to provide a first beam pattern of a high elevation angle and a second beam pattern of a low elevation angle; and
a receiver unit configured to receive a first satellite signal from the antenna array, said receiver unit including a control module disposed to facilitate adjustment of the antenna array so as to optimize reception of the first satellite signal.

2. The system of claim 1 further comprising a location receiver module, said location receiver module disposed to provide receiver location data related to the location of the receiver unit.

3. The system of claim 2 wherein the location receiver module comprises a GPS receiver.

4. The system of claim 2 further comprising a processor module disposed to receive said receiver location data and select, based at least in part on said receiver location data, one of the first beam pattern and second beam pattern to receive the first satellite signal.

5. The system of claim 4 wherein the receiver unit comprises a memory disposed to store a set of satellite location data related to the position of said first satellite.

6. The system of claim 5 wherein the one of the first beam pattern or second beam pattern is selected based at least in part on said receiver location data and said satellite location data.

7. The system of claim 1 wherein said control module includes an electromagnetic device coupled to the antenna array to adjust a position of the antenna array so as to optimize reception of the first satellite signal.

8. The system of claim 7 wherein the electromagnetic device is disposed to rotate a position of the antenna array to change the azimuth angle of the antenna array.

9. The system of claim 7 wherein the electromagnetic device is an electric motor.

10. The system of claim 1 further comprising a processor module; and
a satellite receiver module disposed to receive the first satellite signal from the antenna array and provide a satellite receiver output signal to the processor module, said output signal provided, at least in part, to optimize reception of the first satellite signal.

11. The system of claim 10 wherein the processor module is disposed to select one of the first beam pattern and second beam pattern to receive the first satellite signal responsive to the satellite receiver output signal.

12. The system of claim 11 wherein said selecting is based at least in part on a first signal metric of the first satellite signal.

13. The system of claim 12 wherein the first signal metric is a signal strength.

14. The system of claim 12 wherein the first signal metric is a bit error rate.

15. The system of claim 12 wherein the first signal metric is a signal to noise ratio.

16. The system of claim 12 wherein said selecting is based in part on a second signal metric of the first satellite signal.

17. The system of claim 12 wherein a successive signal metric of the first satellite signal is further used by the receiver unit to facilitate tracking of the first satellite by the antenna array.

18. A Hi/Lo antenna system, comprising:
an antenna array including a plurality of antenna elements configured to provide a first beam pattern of a high elevation angle and a second beam pattern of a low elevation angle; and
a receiver unit configured to receive a first satellite signal from the antenna array, said receiver unit including:
a processor module;
a location receiver module disposed to provide location data related to the location of the receiver unit to the processor module;
a satellite receiver module disposed to receive the first satellite signal from the antenna array and provide a first satellite output signal to the processor module; and
a control module disposed to receive a signal from the processor module to facilitate adjustment of the antenna array so as to optimize reception of the first satellite signal.

19. The system of claim 18 wherein the location receiver module comprises a GPS receiver.

20. The system of claim 19 wherein the processor module is disposed to select one of the first beam pattern and second beam pattern to receive the first satellite signal responsive to said data provided by the location receiver module.

21. The system of claim 20 wherein the processor module is further disposed to track, based at least in part on the first satellite output signal, the first satellite.

22. A method of facilitating satellite signal reception using a Hi/Lo antenna array comprising:
selecting one of a Hi beam pattern and a Lo beam pattern of the antenna array; and
providing, to a control module coupled to the antenna array, a control signal to facilitate adjustment of the antenna array to optimize reception of a signal provided by the satellite.

23. The method of claim 22 further comprising receiving a set of antenna array location data related to the location of the antenna array; wherein said selecting comprises selecting one of a Hi beam pattern and a Lo beam pattern based at least in part on said antenna array location data.

24. The method of claim 22 wherein the location data is provided from a GPS receiver.

25. The method of claim 22 further comprising receiving a satellite signal from the satellite;
providing a signal metric associated with said satellite signal; and
providing, based at least in part on said signal metric, the control signal.
